(19) United States
(12) Patent Application Publication
(10) Pub. No.: US 2018/0096549 A1
(43) Pub. Date: Apr. 5, 2018

(54) LOCK SYSTEM, ELECTRONIC LOCK, AND PORTABLE DEVICE WITH CERTIFICATION FUNCTION AND PAIRING METHOD FOR THE SAME

(71) Applicant: K-Jump Health Co., Ltd., New Taipei City (TW)

(72) Inventor: Chao-Man TSENG, New Taipei City (TW)

(21) Appl. No.: 15/395,994

(22) Filed: Dec. 30, 2016

(30) Foreign Application Priority Data
Sep. 30, 2016 (TW) 105131713

(51) Int. Cl. G07C 9/00; E05B 47/00; E05B 67/00; E05B 47/06

(52) U.S. Cl. CPC G07C 9/00309; E05B 47/0012; G07C 2009/00769; E05B 47/0603; E05B 67/00

(57) ABSTRACT

A lock system with certification function includes an electronic lock and a portable device. The electronic lock has a lock structure and a certification circuit. The certification circuit has a database for storing at least one certification code. The lock structure defines a close path. The portable device is used for transmitting certification information. When the electronic lock receives the certification information, the certification circuit verifies whether the received certification information has data identical to one of the least one certification code. If the certification information is valid, the closed path is changed to an open path.

### BACKGROUND OF THE INVENTION

### Field of the Invention

The technical field relates to a lock system, an electronic lock, a portable device and a pairing method for the same, and more particularly related to an electronic lock, and a portable device with a certification function, and a pairing method for the same.

### Description of Related Art

In today's society, long-term global economic downturn has caused the unemployment rate of many countries to rise, which indirectly results in the deterioration of social order. The continuous increase in theft or breaking-and-entering undoubtedly makes people feel unsafe. As a consequence, people urgently need effective means of crime prevention, in light of the increased threats to their security and property.

Many objects have the need for a lock system, such as the doors and windows of buildings, the doors, steering wheels, and engine switches of vehicles, or some boxes etc., as it prevents people's property or security from being threatened. A general lock system needs to comprise a locking device and a key matching with the locking device. The key generally comprises a specific structure to match with the locking device, such as different groove structures and a specific design of scale and depth of the grooves, so as to make each key only applicable to unlock the specific locking device, achieving the purpose of anti-theft. However, in many cases, it is easy to duplicate the above-mentioned key because any duplicate key can be used to unlock the lock device as long as the duplicate key's shape is consistent with the specific shape. As a result, the above-mentioned key is very easy to be duplicated by other people.

Additionally, every locking device needs a corresponding key. Simultaneously carrying a plurality of keys is not convenient. Although only carrying the necessary keys which are needed at a specific time can reduce the burden of carrying every key, people still tend to forget the necessary keys at home.

### SUMMARY OF THE INVENTION

The object of the present disclosed example is to solve above-mentioned problems of the related art. When using the present disclosed example, people can conveniently unlock the lock device, and reduce the inconvenience of carrying the lock device and leaving the necessary key device at home.

One of the disclosed examples, a lock system with certification function, comprises:

an electronic lock comprising a lock structure and a certification circuit, the certification circuit comprising a database for storing at least one certification code, the lock structure used to define a close path; and

a portable device used to transmit certification information;

wherein the certification circuit verifies whether the received certification information has data identical to the at least one certification code after the electronic lock receives the certification information of the portable device, and the electronic lock makes lock structure change to an open path from the closed path if the certification information is identical to the at least one certification code.

One of the disclosed examples, an electronic lock with certification function, comprises:

a certification circuit used to receive data sent from an external device and determining according to the data whether to generate a release signal;

a lock-releasing circuit coupled to the certification circuit and making a mechanical device translate into a non-lock status from a lock status when receiving the release signal; and

a power stabilizing circuit used to receive electricity and filter out the ripple in the electricity, and continuously outputting electrical power, which is not less than a predetermined power value, for a predetermined time or more to the certification circuit and the lock-releasing circuit.

One of the disclosed examples, a portable device with certification function, comprises:

a storage circuit storing data;

a data output circuit coupled to the storage circuit and transmitting the data when being induced by an electronic lock or receiving a transmission command sent by a user; and

a built-in power source, providing the necessary electricity for making the storage circuit and the data output circuit operate.

One of the disclosed examples, a pairing method of an electronic lock with certification function, comprises:

establishing a connection between the electronic lock and a first portable device for receiving data for certification;

comparing the certification data for certification with at least one certification code stored in a database of the electronic lock for verifying whether the certification data has data identical to one of the least one certification code;

storing at least part of the data of the certification data for certification in the database if the certification data has data identical to one of the least one certification code; and

modifying a flag from an unpaired status into a paired status.

Via above-mentioned technical scheme, the lock system of the present disclosed example can make the portable device match with the electronic lock, reduce inconvenience of carrying the lock device and leaving the necessary key device at home. Besides, the electronic lock cannot be limited to a single portable device, and prevent the problem of missing the portable device.

### BRIEF DESCRIPTION OF DRAWING

The features of the present disclosed example believed to be novel are set forth with particularity in the appended claims. The present disclosed example itself, however, may be best understood by reference to the following detailed description of the present disclosed example, which describes an exemplary embodiment of the present disclosed example, taken in conjunction with the accompanying drawings, in which:

FIG. 1A is a schematic view of a lock system according to an embodiment of the present disclosed example;

FIG. 1B is a schematic view of an electronic lock of FIG. 1A translating into open path from close path;

FIG. 2 is a schematic view of a portable device according to an embodiment of the present disclosed example;

FIG. 3 is a flowchart of a portable device and an electronic lock pairing operation according to an embodiment of the present disclosed example;

FIG. 4 is a flowchart of a portable device and an electronic lock unlocking operation according to an embodiment of the present disclosed example;

FIG. 5 is a flowchart of a second or more portable device and an electronic lock pairing operation according to an embodiment of the present disclosed example;

FIG. 6 is a flowchart of resetting or re-pairing an electronic lock using a portable device according to an embodiment of the present disclosed example;

FIG. 7A is a schematic view of a lock system according to another embodiment of the present disclosed example;

FIG. 7B is an appearance view of an electronic lock of FIG. 7A;

FIG. 8 is a schematic view of a mechanical device of an electronic lock under a non-lock status according to another embodiment of the present disclosed example;

FIG. 9 is a schematic view of a mechanical device of an electronic lock translating into a lock status from a non-lock status according to another embodiment of the present disclosed example; and

FIG. 10 is a schematic view of a mechanical device of an electronic lock under a lock status according to another embodiment of the present disclosed example.

### DETAILED DESCRIPTION OF THE INVENTION

In cooperation with attached drawings, the technical contents and detailed description of the present disclosed example are described thereinafter according to a preferable embodiment, being not used to limit its executing scope. Any equivalent variation and modification made according to appended claims is all covered by the claims claimed by the present disclosed example.

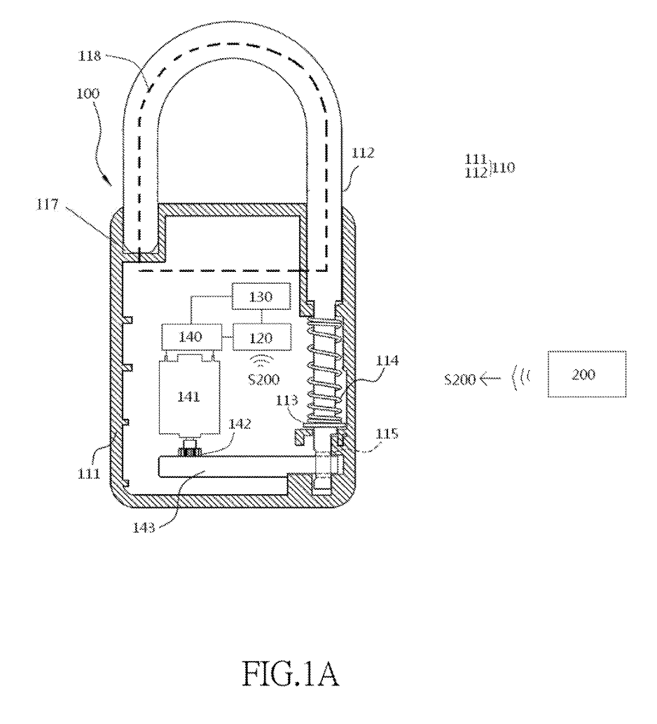

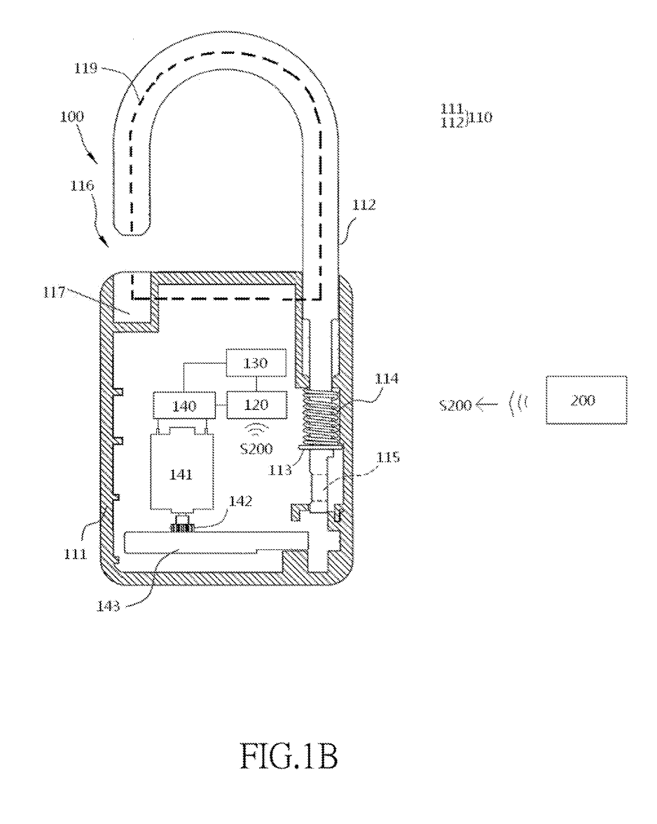

First, please refer to FIG. 1A, which illustrates a schematic view of a lock system according to an embodiment of the present disclosed example. In this embodiment, the lock system has a certification function and comprises an electronic lock 100 and a portable device 200. The electronic lock 100 comprises a lock structure 110 and a certification circuit 120. The certification circuit 120 comprises a database (not shown in the figure) for storing at least one certification code. The lock structure 110 comprises a lock case 111 and a shackle 112. When the electronic lock is under a lock status, the lock structure 110 defines a close path 118 for locking up the anti-theft object in the close path 118, so as to achieve the effect of anti-theft. The portable device 200 is used to transmit certification information S200 to the electronic lock 100 wirelessly or in wire. After the electronic lock 100 receives the certification information S200 of the portable device 200, the certification circuit 120 verifies whether the certification information S200 has data identical to the at least one certification code stored in the database. If the certification information S200 has data identical to the at least one certification code, the electronic lock 100 makes the lock structure 110 translate into an open path 119 from the close path 118, namely, generates a gap 116 for make a user move the anti-theft object away via the gap 116. Please refer to FIG. 1B, which illustrates a schematic view of an electronic lock of FIG. 1A translating into open path from close path.

In an embodiment, the electronic lock 100 can further comprise a power stabilizing circuit 130 and a lock-releasing circuit 140. The lock-releasing circuit 140 is coupled to the certification circuit 120. When the certification circuit 120 verifies that the received certification information S200 has data identical to any certification code, the certification circuit 120 generates and transmits a release signal to the lock-releasing circuit 140. When receiving the release signal, the lock-releasing circuit 140 controls a mechanical device to translate into a non-lock status from a lock status for making the close path 118 translate into the open path 119. The power stabilizing circuit 130 is used to receive the electricity and filter out the ripple in the electricity. The power stabilizing circuit 130 continuously outputs electrical power for a predetermined time (such as 5 seconds) or more, or continuously outputs electrical power with power value is not less than a predetermined power value (such as 1 mW) to the certification circuit 120 and the lock-releasing circuit 140. In this embodiment, the mechanical device comprises a motor 141, a gear 142 and a transverse rod 143. The motor 141 can be controlled by the lock-releasing circuit 140 to rotate a shaft and drive the gear 142. The gear 142 engages one end of the transverse rod 143, so as to drive the transverse rod 143 to move leftward or rightward when the gear 142 rotates. One end of the shackle 112 comprises a lock hole 115. When the transverse rod 143 passes in or through the lock hole 115, such as applying force to the shackle 112 to make the shackle 112 move down to a lock position so as to make the lock hole 115 locate right side of the transverse rod 143, and make the transverse rod 143 pass in or through the lock hole 115 rightward for latching the shackle 112, the mechanical device is under the lock status. At this time, the lock case 111 and the shackle 112 defines the close path 118 together. When the transverse rod 143 moves away the lock hole 115, such as the motor 141 driving the gear 142 so as to drive the transverse rod 143 to move out from the lock hole 115 leftward and detach from the shackle 112, so as to make the shackle 112 move up to an unlock position and from the gap 116, the mechanical device is under the non-lock status. At this time, the shackle 112 can be moved up relative to the lock case 111 and from the gap 116, so as to make the lock case 111 and the shackle 112 together define the open path 119.

In another embodiment, the electronic lock 100 may comprise a spring 114; the spring 114 locates in the lock case 111 and is jointed with the one end of the shackle 112. The shackle 112 comprises a baffle 113 inside for clamping the position of one end of the spring 114. When the shackle 112 is applied force to move up and forms the gap 116, the spring 114 is compressed and stores energy, so as to provide a restoring force used to make the shackle 112 move back to the lock position when the shackle 112 is released.

The portable device 200 may be a hand-held device, a wearable device or any small device with power source. For example, a cellphone, watch, MP3 Walkman, wearable device or other electronic device with wireless or wire transmission interface can be used. In the first-time usage, the portable device 200 must first pair with the electronic lock 100. After successfully pairing, the electronic lock 100 can store all or part of the data of the certification information transmitted by the portable device 200 in a database of the certification circuit 120 as a certification code. Or, the portable device 200 may only store certification data. The database of the certification circuit 120 may be the Read-Only Memory (ROM), Programmable Read-Only Memory (PROM), Erasable Programmable Read Only Memory (EPROM), One Time Programmable Read Only Memory (OTPROM), Electrically-Erasable Programmable Read-Only Memory (EEPROM), Flash Memory or a combination thereof, the database may also be the other circuit used to store data. Preferably, the circuit of the database can be erased and written repeatedly. Preferably, the circuit of the database is the circuit that can still save the stored data even without electricity (non-volatile). Thereby, the user can modify the related information of the portable device 200, add/delete the related information of the portable device 200, and prevent the problem that the configured data stored in the electronic lock 100 will lose under the status of no electricity. The detail flow of pairing and unlock will be described later.

Preferably, as shown in FIG. 1A and FIG. 1B, the left-side of the lock case 111 forms a shackle-accommodating space 117 used to accommodate one side (such as the left-side of FIG. 1A, 1B) of the shackle 112 after locking. The above-mentioned shackle-accommodating space 117 is completely isolated from an internal space (namely, the space which each circuit component locates) of the electronic lock 100. Additionally, the other side (such as the right-side of FIGS. 1A, 1B) of the shackle 112 passes through a waterproof O-ring (not shown in the figure) and is inserted into the lock case 111. Via installing the waterproof O-ring, the junctions of the shackle 112 and the lock case 111 can be sealed and provides the waterproof effect. The electronic lock 100 of the present disclosed example can effectively reduce the number and cost of waterproof structures because the electronic lock 100 needs to install the waterproof structure in only one side of the shackle 112. Furthermore, because the number of waterproof structures is less, the present disclosed example can further reduce the probability of damaging the electronic lock 100 due to water flowing into the interior of the electronic lock 100 by the malfunction of the waterproof structure (such as the waterproof O-ring aging).

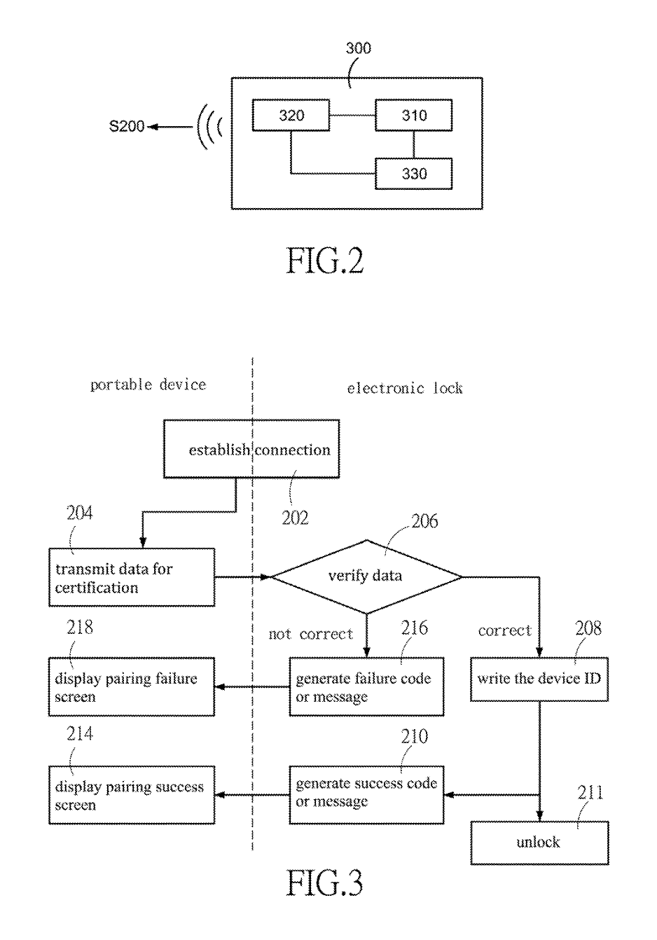

Please refer to FIG. 2, which illustrates a schematic view of a portable device according to an embodiment of the present disclosed example. The portable device shown in FIG. 2 as the portable device of the lock system of the present disclosed example can pair with the electronic lock. The portable device 300 shown in FIG. 2 is similar to the portable device 200 shown in FIGS. 1A, 1B; the relevant description is omitted for brevity. In this embodiment, the portable device 300 has a certification function, and comprises a storage circuit 310, a data output circuit 320 and a built-in power source 230. The storage circuit 310 stores data. The data output circuit 320 is coupled to the storage circuit 310, and transmits the data, such as above-mentioned certification information S200, when induced by an electronic lock (such as the electronic lock 100 shown in FIG. 1A, 1B) or receiving a command transmitted from a user. The built-in power source 330 provides the necessary electricity for making the storage circuit 310 and the data output circuit 320 operate. The built-in power source 330 can be a disposable power source, such as an alkaline battery, or a rechargeable power source, such as a nickel-metal hydride rechargeable battery or a lithium battery.

In an embodiment, an unlocking program is first installed in the portable device. After the user executes the unlocking program, the executed unlocking program can control the data output circuit 320 to set the data stored in the storage circuit 310 as the certification information and transmit the certification information to the electronic lock in wire or wireless form, so as to execute each function of pairing, unlock and so forth.

In another embodiment, the portable device may automatically detect whether the portable device connects to the electronic lock in wire or wirelessly detects whether the electronic lock is moved close to the portable device within a predetermined distance. If so, the data output circuit 320 sets the data stored in the storage circuit 310 as the certification information and transmits the certification information to the electronic lock wirelessly or in wire.

In an embodiment, the electronic lock and the portable device comprise a NFC module (not shown in figure) respectively. When the portable device is moved close to the electronic lock within the predetermined distance (such as 20 cm or less), the portable device establishes a connection with the electronic lock for automatically or manually transmitting the certification information via NFC. The certification information comprises a certification key, a user password, at least one device ID of the portable device or a combination thereof. The device ID may be any specific identification of the internal circuit/module in the portable device, such as an IMEI code of cellphone, a MAC address of Wi-Fi device, a Bluetooth address of Bluetooth device, a serial number of the portable device, a NFC serial number of NFC module and so forth. The certification key is used to reset the electronic lock and/or re-pair the electronic lock with a new portable device if the user loses the user's original paired cellphone. The user password is set by the user, and when the portable device is lost, the user password prevents someone who picks up the lost device from unlocking the electronic lock, namely, preventing the security of the electronic lock from being reduced.

In an embodiment, the electronic lock may comprise a display device. When the certification successes or the electronic lock is unlocked, the display device notifies the user in form of display. The display device may be LCD screen, OLED screen, electronic paper and so forth. In another embodiment, the electronic lock comprises a lighting component (such as LED indicator light) or a sounding component (such as buzzer or speaker), but doesn't comprises a display device. When the certification information transmitted from the portable device has data identical to one of the least one certification code, the lighting component lights for a predetermined time continuously or periodically, or the sounding component is sounded for the predetermined time continuously or periodically, so as to notifying the user of that the certification's success or when the electronic lock is unlocked. Depending on operation design of the display device, the lighting component or the sounding component (e.g., the time period of notification, the notification volume/brightness, and so on), the power consumption can be reduced. In other words, when the electronic lock comprises a built-in power source, such as lithium battery or dry battery, the electronic lock can achieve the advantage of extending the life of the built-in power source.

In some embodiments, the electronic lock may be dispensed with the lighting component, the sounding component, the display device and any other notification device, in which the electronic lock returns information of succeeding in certification or unlocking the portable device. When the portable device receives the information, the portable device notifies the user via its lighting component, sounding component and/or display device.

In another embodiment, the electronic lock and the portable device may comprise at least one notification device (such as lighting component, sounding component and display device) of above-mentioned embodiments respectively, and independently notifies the user of the certification's success or that the electronic lock is unlocked, or another message that successfully notifies the user even when the notification device of either the electronic lock and the portable device fails.

The electronic lock may fail in locking/unlocking operation normally when the built-in power source of the electronic lock supplies an insufficient current. The electronic lock may notify the user, such as the lighting component flashing periodically for notifying the user of replacing or charging the built-in power source when the power remaining of the built-in power source is less the a predetermined value or voltage thereof is less than a predetermined voltage value.

In an embodiment, the electronic lock doesn't comprise the built-in power source, but receives the power required for operation from an external device via the wire or wireless form. The external device can be a portable device with certification function or other external device with power source. For example, the electronic lock and the external device comprise a wire transmission interface, respectively. The wire transmission interface of the electronic lock is coupled to the power stabilizing circuit 130 and used to connect to the wire transmission interface of the external device via a cable. The external device transmits power via the wire transmission interfaces and the cable connected there between to the power stabilizing circuit 130. For example, the wire transmission interface could be a headphone interface, a USB interface, a Lightning interface or an IEEE 1394 interface.

In another embodiment, the electronic lock receives power required for operation via wireless form. For example, the electronic lock receives energy of light waves, sound waves or electromagnetic waves (such as radio frequency), and transforms the received energy into electrical energy. In this embodiment, the electronic lock further comprises an induction circuit coupled to the power stabilizing circuit. The external device generates the electromagnetic waves, the induction circuit is induced by the electromagnetic waves generated by the external device to generate the electrical energy (current) to the power stabilizing circuit. When receiving the electrical energy, the power stabilizing circuit has the ability to immediately or later output the power to the certification circuit, the lock-releasing circuit and other additional circuitry, wherein the power value is not less than a predetermined power value. This scheme can prevent the electronic lock from failing in unlocking when the built-in power source supplies insufficient power or is out of juice. The wireless form of the electronic lock may be Near Field Communication (NFC), Radio Frequency Identification (RFID), sound-driven nanogenerators or light-inducing circuits (such as solar panels) which have the ability to receive energy to transform into electrical energy. The external device with certification function or the other external device with power source correspondingly comprises an induction coil of NFC, an induction coil of RFID, lighting component or sounding component for transmitting energy to the electronic lock. Of course, transmitting energy in wireless or wire form may simultaneously transmit the certification information. Namely, the certification information may be transmitted by the headphone interface, the USB interface, the Lightning interface, or the IEEE 1394 interface of the wire form, or the induction coil of NFC, the induction coil of RFID, the variety of audio frequency, the variety of audio intensity or combination thereof, the variety of light frequency, the variety of light intensity or the combination thereof of the wireless form.

However, whether it is through wireless form or wire form, the transmission of energy may be restricted within the form of transmission or the restrictions of the specifications of the transmission/reception circuit such that the conversion efficiency of energy is slow and poor. If the external device cannot provide enough power in real-time to the internal circuits of the electronic lock in some application environments, those circuits cannot operate, abnormally operate or erroneously operate. Thus, the power stabilizing circuit may comprise a capacitance or the other similar element used to filter and store energy. When the accumulation of energy is sufficient, the power stabilizing circuit can continuously output electrical power, which is not less than a predetermined power value, for a predetermined time or more so as to make the internal circuits of the electronic lock normally operate until completing the operation or action. To ensure that the energy accumulation time in wireless or wire form is not too long, the power provided by the external device or received by the electronic lock is 1 mW or more.

Of course, the electronic lock can simultaneously comprise the built-in power source and the power receiving device in wire and/or wireless form. The built-in power source can provide the function of fast unlock. When the built-in power source is not supplying enough power or is out of juice, the electronic lock can still receive power required for operation and complete the unlock operation via the wire and/or wireless power receiving device. Additionally, the accommodating structure of the built-in power source (such as a button battery, a lithium battery or a dry battery) may be designed to be locked under the locked status and not be removed. Under the non-lock status, the accommodating structure simultaneously is unlocked so as to allow the built-in power source to be removed or replaced.

Please be noted that although the above-mentioned embodiments use the padlock to explain, this specific example is not intended to limit the scope of the present disclosed example. In the practical application, the lock system, the electronic lock and portable device may be applied to the other type of anti-theft lock, such as a door lock, luggage lock, bicycle lock and so on.

Please refer to FIG. 3, which illustrates a flowchart of a portable device and an electronic lock pairing operation according to an embodiment of the present disclosed example. In this embodiment, if the electronic lock has not yet been paired with any portable device, its status is “unpaired”. This could be the case if the electronic lock is newly purchased by the user or is reset by the user even if it had been paired before. In step 202 of establishing a connection, the electronic lock establishes the connection with the portable device to receive a data for certification. The connection may be established via wire or/and wireless form. Via establishing the connection, the portable device confirms that it is allowed to communicate with the electronic lock and transmits the data. Further, at the same time as, or after establishing the connection, the electronic lock may transmit information in advance, so as to provide the portable device the basic information of identifying the electronic lock, such as the type, serial number, status and so forth of the electronic lock. In step 204 of transmitting the data for certification, the portable device transmits the data (such as above-mentioned certification information S200) for certification to the electronic lock. The data may comprise the certification key, the identification code of the electronic lock, the user password, at least one device ID of the portable device or a combination thereof. The device ID may be an IMEI code, a MAC address, a Bluetooth address, a serial number of the portable device, a NFC serial number or a combination thereof. Furthermore, the data may comprise a pairing command provided to electronic lock for identification and execution. The identification code of the electronic lock is generated by computing according to the data of the electronic lock, such as the serial number of the electronic lock for making the electronic lock identify the right buyer according to the certification key. The user may obtain the certification key when purchasing the electronic lock of the present disclosed example or applying via network. The manufacturers may provide a product registration via network, and so the user registers the purchased product for registering with the user's personal information and the information of the purchased electronic lock. After registration, the manufacturers can determine whether the manufacturers must provide the certification key according to the registered personal information and information of the electronic lock. In step 206 of verifying the data, the certification data is compared with at least one certification code stored in a database of the electronic lock for verifying whether the data has data identical to the at least one certification code. For example, the value of the specific position, column or range of the data is verified to be identical to one of the least one certification code. The purpose of verifying the data is to determine whether or not the electronic lock pairs with the portable device. For example, the pairing confirmation may be achieved by comparing at least one of the certification key, the identification code of the electronic lock and the user password with at least one certification code stored in the electronic lock. In step 208 the device ID is written in. After verifying that the data is identical to the certification code, the electronic lock writes (namely, stores) the at least part of the data in the database of the electronic lock. In this embodiment, the electronic lock writes the device ID in the certification circuit of the electronic lock for completing the pairing operation. In the other embodiment, the portable device may store the data from the electronic lock for completing the pairing operation. In step 210 of generating success code or message. After completion of pairing the portable device and the electronic lock, the electronic lock generates the success code or message. For example, the electronic lock modifies a flag from unpaired status into paired status, and the success code or message is the flag of paired status. The success code or message may actively transmit to the portable device from the electronic lock, or be passively requested in the electronic lock by the portable device. In step 211 of performing unlocking, after success of pairing, the electronic lock may simultaneously unlock, namely, transform into the non-lock status from the lock status. In step 214 of displaying pairing success screen, the portable device displays the pairing success screen according to the success code or message for notifying the user of the pairing result. In the other embodiment, the present disclosed example may select all or one of step 211 and step 214 to perform. However, in step 216 of generating failure code or message, if verifying that the data is not identical to any certification code, the electronic lock generates the failure code or message. Similarly, the failure code or message may actively transmit to the portable device from the electronic lock, or be passively requested in the electronic lock by the portable device. In step 218 of displaying the pairing failure screen, the portable device displays the pairing failure screen according to the pairing failure code or message for notifying the user of the pairing result.

After the pairing operation shown in FIG. 3, the electronic lock has paired with the portable device, which is the first portable device. The status of the electronic lock has translated into the paired status from unpaired status. The electronic lock under the paired status cannot pair with another portable device to ensure the security of electronic lock unless receiving the command of adding a pairing device from the first portable device.

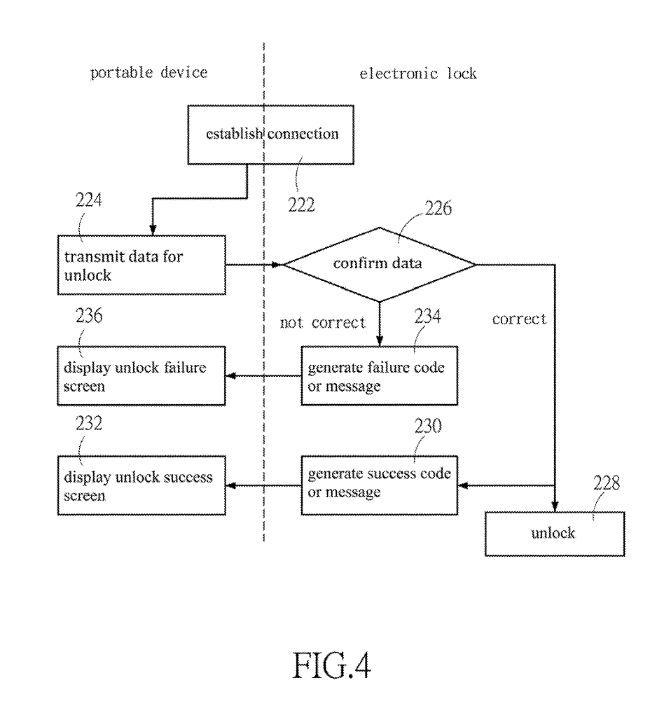

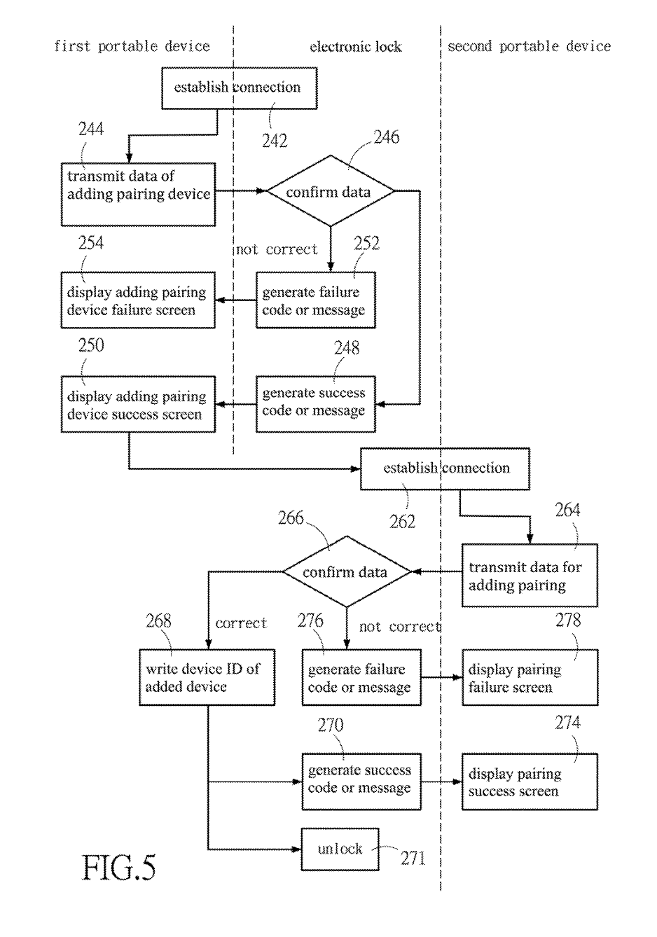

Please refer to FIG. 4, which illustrates a flowchart of a portable device and an electronic lock unlocking operation according to an embodiment of the present disclosed example. First, in step 222 of establishing a connection, the portable device establishes the connection with the electronic lock. The portable device may establish the connection via wire or wireless form. Via establishing the connection, the portable device confirms that it is allowed to communicate with the electronic lock. Furthermore, the electronic lock may transmit information in advance, so as to provide the portable device the basic information of identifying the electronic lock, such as type, serial number, status and so forth of the electronic lock. In step 224 of transmitting the data for unlocking, the portable device transmits the data for unlocking to the electronic lock. In this step, the portable device may display the screen of guiding the user to input the user password. After the user inputs the user password and clicks the unlock icon, the portable device transmits the data for unlocking. Alternatively, the portable device automatically transmits the pre-stored information for unlocking. For example, after the certification successes shown in FIG. 3, the portable device can additionally perform a step of storing information to store the certification key, the device ID of the electronic lock, the user password and so forth inputted by the user, and automatically obtain and transmit the stored information during following operations. Additionally, the data for unlocking may comprise an unlock command. In step 226 of confirming the data, the electronic lock confirms whether the data is correct. If so, the electronic lock performs step 228 to unlock, and/or performs step 230 to generate success code or message. In step 232 of displaying unlock success screen, the portable device displays unlock success screen according to the success code or message for notifying the user. If the electronic lock confirms that the data is not correct, the electronic lock performs step 234 to generate failure code or message. In step 236 of displaying unlock failure screen, the portable device displays an unlock failure screen according to the failure code or message for notifying the user. As mentioned above, the success code or message and the failure code or message may actively be transmitted to the portable device from the electronic lock, or be passively requested in the electronic lock by the portable device.

The electronic lock is capable of being paired with multiple portable devices by the first portable device, such as the portable device(s) of the user's family or authorized people for the scenario of duplicating multiple keys in practical application. Additionally, the user can freely configure the pairing data of the second and the other portable device. The present disclosed example not only provides convenient configuration, but also saves the cost of an additional physical copy of the key.

Please refer to FIG. 5, which illustrates a flowchart of a second or more portable device and an electronic lock pairing operation according to an embodiment of the present disclosed example. In this embodiment, the first portable device (such as the first paired portable device hold by the user) has full permissions (such as simultaneously administrator permission and unlock permission), and has the ability to grant the unlock permission to the other one or more portable devices (such as the portable device held by the user's family or authorized people, hereinafter the second portable device) for granting the second portable device the unlock permission.

First, in step 242 of establishing a connection, the first portable device having the full permissions (such as the portable device hold by the user) establishes the connection with the electronic lock for confirming that the first portable device is allowed to communicate with the electronic lock. Furthermore, the electronic lock can transmit information in advance, so as to provide the first portable device the basic information of identifying the electronic lock, such as type, serial number, status and so forth of the electronic lock. In step 244 of transmitting data of adding a pairing device, the first portable device transmits the data of adding a pairing device to the electronic lock. The data of adding a pairing device comprises the certification key, the identification code of the electronic lock, the user password, at least one device ID of the first portable device or a combination thereof. Additionally, the data comprises a command of adding a pairing device. In step 246 of confirming data, the electronic lock confirms whether the received data has data identical to one of the at least one device ID. If so, the electronic lock performs step 248 to generate a success code or message, and performs the command of adding a pairing device for entering a status of adding a pairing device. In step 250 the adding a pairing device success screen is displayed, after the first portable device receives the success code or message, the first portable device displays the adding a pairing device success screen. However, if the electronic lock confirms that the received data is not identical, the electronic lock performs step 252 to generate a failure code or message. In step 254 the adding a pairing device failure screen is displayed, after the first portable device receives the failure code or message, the first portable device displays the adding a pairing device failure screen.

In step 262 of establishing connection, after the user watches the adding a pairing device success screen on the first portable device, the user can make the second portable device which the user wants to grant the unlock permission connect to the electronic lock in a wire form, or in a wireless form that may establish the connection via moving close to the electronic lock within a distance. In step 264 of transmitting data for adding a pairing, the second portable device transmits the data for adding a pairing. The data may comprise the certification key, the identification code of the electronic lock, the user password, at least one device ID of the second portable device or a combination thereof, wherein the user password is inputted by the user manually for preventing the probability of adding the other people's device under the status of adding a pairing device caused by faulty operation of the user. Or, the electronic lock may leave the status of adding a pairing device after the predetermined time elapses since entering the status of adding a pairing device, so as to prevent from anti-theft risk of incorrectly allowing the other people to add device. In step 266 of confirming data, the electronic lock confirms whether the data transmitted form the second portable device is correct. If so, the electronic lock performs step 268 of writing in the device ID of added device, to write the device ID of the second portable device in the certification circuit of the electronic lock for completing adding a pairing. Then, in step 270 of generating a success code or message, the electronic lock generates a success code or message and transmits it to the second portable device actively or passively after requested. In step 274 of displaying the pairing success screen, after the second portable device receives a success code or message, the second portable device displays the pairing success screen for notifying the user of success of adding a pairing. Or, the portable device performs step 271 to unlock to notify the user in the form of unlocking. However, if the electronic lock confirms that the data transmitted from the second portable device is incorrect, the electronic lock performs step 276 to generate a failure code or message. In step 278 of displaying a pairing failure screen, after the second portable device receives the failure code or message, the second portable device displays a pairing failure screen for notifying the user that the adding pairing failed.

Above-mentioned data transmission between the portable device and the electronic lock may be performed by method of packet switching, which groups data into suitably sized blocks. The method of packet data optimizes the connection loading capacity between the portable device and the electronic lock, minimizes the response time thereof, and increases robustness of data. Preferably, the packet data can be encrypted to protect the transmitted data.

Please be noted that in the situation the user has lost the first portable device, and so has no ability to add a device anymore (namely, the user has no ability to add a new portable device having the unlock permission), if the user only has one paired portable device (the first portable device) and there is no other portable device having the unlock permission, the electronic lock will no longer be used. Furthermore, the objects locked by the electronic lock cannot be obtained.

For preventing the aforementioned situation from occurring and keeping the anti-theft capability of the electronic lock simultaneously, the electronic lock of the present disclosed example may reset the status of the electronic lock (namely, restoring the electronic lock to the unpaired state, such as factory state) or re-pair the electronic lock to another portable device as a new first portable device. Like the old first portable device, the new first portable device also has the full permissions.

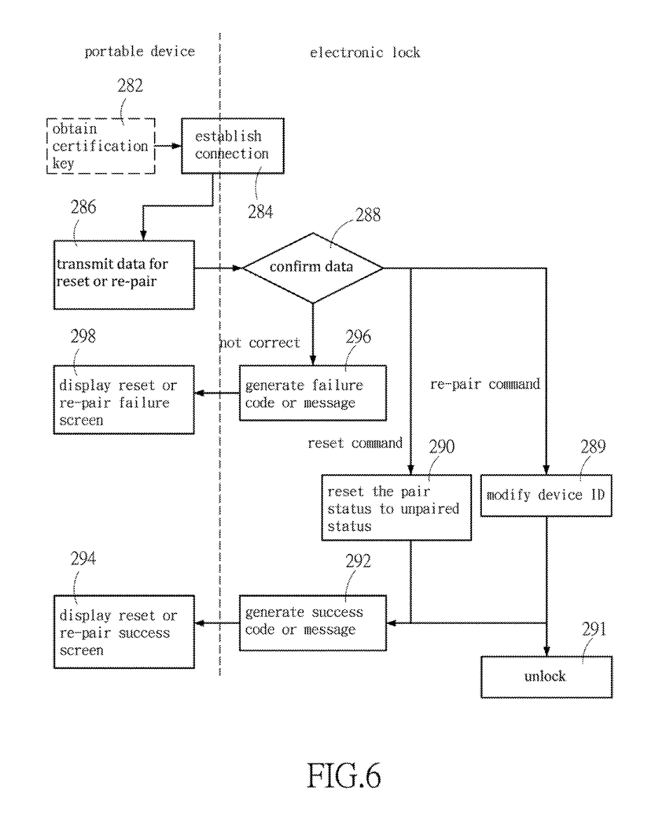

Please refer to FIG. 6, which illustrates a flowchart of resetting or re-pairing an electronic lock using a portable device according to an embodiment of the present disclosed example. In this embodiment, the electronic lock had been paired with the first portable device (namely, the old first portable device). The user may operate the old first portable device to reset the electronic lock or pair the new first portable device with the electronic lock. Furthermore, if the old first portable device, which is the only one with administrator permission is lost, the user may operate another portable device (namely, the new first portable device) and the electronic lock to perform the following steps for resetting the paired status of the electronic lock or granting the new first portable device the administrator permission. The following description will take operating the new first portable device for example to explain.

In Step 282 of obtaining the certification key, the new portable device obtains the certification key. The certification key may be obtained when purchasing the electronic lock, or by downloading or E-mail via network, SMS and so forth afterwards.

Then, in step 284 of establishing connection, the new portable device establishes a connection with the electronic lock. Via establishing the connection, the new first portable device confirms that it is allowed to communicate with the electronic lock. Furthermore, the electronic lock can transmit information in advance, so as to provide the portable device the basic information of identifying the electronic lock, such as type, serial number, status and so forth of the electronic lock.

In step 286 of transmitting data for reset or re-pair, the new portable device transmits the data for resetting or re-pairing the electronic lock. The data may comprise the certification key, the reset command, a re-pair command and at least one device ID of the new portable device, the identification code of the electronic lock, the user password or a combination thereof.

In step 288 of confirming data, the electronic lock receives the data and determines whether the electronic lock resets the paired status or repairs with the portable device.

In step 290 of resetting the paired status to unpaired status, when confirming that the data is correct and the data comprises the reset command, the electronic lock modifies the status to the unpaired status from paired status, and clears the device ID (namely, the stored device ID of the old first portable device) stored in the certification circuit of the electronic lock. Thus, the user can remove the administrator permission of the old first portable device, and can use another portable device (such as the new first portable device) to pair with the electronic lock according to the operation flow shown in FIG. 3. Please be noted that if the data comprises the reset command, the electronic lock only removes the administrator permission of the old first portable device, and doesn't grant the new first portable device the administrator permission.

Or, in step 289 of modifying device ID, when the electronic lock confirms that the data is correct and the data comprises the re-pair command, the electronic lock modifies the device ID of the old first portable device stored in the certification circuit of the electronic lock to the current device ID (namely, the device ID of the new first portable device), so as to remove the administrator permission of the old first portable device. Of course, the user can selectively keep or clear the device ID of the other portable device stored in the certification circuit, such as at the same time of granting the new first portable device the administrator permission, keeping the unlock permission of the old second portable device.

In step 291 of unlocking, after re-pair success, the electronic lock can simultaneously unlock. Namely, the electronic lock translates to the non-lock status from the lock-status.

In step 292 of generating success code or message, after complement of reset or re-pair, the electronic lock generates success code or message. The success code or message may be actively transmitted to the new first portable device from the electronic lock, or be passively asked in the electronic lock by the new first portable device.

In step 294 of displaying reset or re-pair success screen, the new first portable device displays reset or re-pair success screen according to the pair success code or message for notifying the user of the execution result.

In the other embodiment, the present disclosed example may perform all or one of steps 291, 292 and 294. However, if confirming that the data is incorrect or has data not identical thereto, the electronic lock performs step 296 of generating failure code or message. Similarly, the pair failure code or message may actively be transmitted to the new first portable device from the electronic lock, or be passively asked in the electronic lock by the new first portable device.

In Step 298 of displaying reset or re-pair failure screen, the new first portable device displays reset or re-pair failure screen according to the reset or re-pair failure code or message for notifying the user of the execution result.

Preferably, the new first portable device may obtain the old certification key (namely, the certification key corresponding to the old first portable device) and new certification key (namely, the certification key corresponding to the new first portable device). Besides, in step 286, the data may simultaneously comprise the old certification key and the new certification key. In step 288, the data is confirmed by the electronic lock to simultaneously comprise the old certification key and the new certification key. In step 289, the electronic lock replaces the old certification key stored in the certification circuit with the new certification key when the electronic lock confirms that the old certification key is correct. Thereby, it ensures that there is only one portable device which can reset or re-pair the electronic lock via certification key, so as to enhance the security of reset or re-pair (namely, ensuring that there is only one portable device having the administrator permission).

Although the above-mentioned description takes losing the old first portable device and using the new first portable device to execute the reset or re-pair operation for example, this specific example is not intended to limit the scope of the present disclosed example. In the other embodiment of the present disclosed example, the electronic lock may be reset by the old first portable device according to the operation flow shown in FIG. 6 when the old first portable device which has been paired with the electronic lock is not lost, so as to transfer the user of the electronic lock or other operations (e.g., removing the administrator permission from the old portable device, or transferring the administrator permission to the new first portable device of the other one from the old first portable device of the user).

More specifically, when the old first portable device is not lost, the user may use the user password and the device ID of the old first portable device instead of the certification key. Namely, step 282 shown in FIG. 6 may be omitted, and step 284 may be directly performed for establishing the connection between the old first portable device and the electronic lock. Additionally, the data in step 286 at least comprises the user password, the reset command or re-pair command and the device ID of the old first portable device.

Then, the electronic lock performs step 288 for confirming whether the data is correct. If not, the electronic lock performs step 296 and 298. If so, the electronic lock further confirms that the data comprises the reset command or the re-pair command.

If the electronic lock confirms that the data is correct and comprises the re-pair command in step 288, the electronic lock performs step 289 for modifying the device ID of the old first portable device stored in the certification circuit of the electronic lock to the device ID of the new first portable device. Preferably, during performing step 289, the present disclosed example guides the user through connecting the new first portable device to the electronic lock for making the electronic lock obtain the device ID of the new portable device. Thus, the user can transfer the administrator permission to the new first portable device from the old first portable device directly. Then, the electronic lock performs step 291 or step 292 and/or the new first portable device performs step 294.

If the electronic lock confirms that the data is correct and comprises the reset command in step 288, the electronic lock performs step 290 for modifying the status of the electronic lock into the unpaired status from the paired status, and cleans the device ID (namely, the device ID of the old first portable device) stored in the certification circuit of the electronic lock. Then, the electronic lock performs step 291 or step 292 and/or/the old first portable device performs step 294. Furthermore, after resetting, the user can re-pair another portable device with the reset electronic lock as the new first portable device. Of course, the above-mentioned operation flow can apply to the other portable device, and the function of the present disclosed example can still be achieved. Please be noted that one portable device can pair with multiple electronic locks. Thus, the user can use the single portable device to replace the multiple keys for enhancing the convenience of usage. In another embodiment, the portable device can display the corresponding user interface or later transmits data of corresponding type of the command and/or content according to the basic information of electronic lock

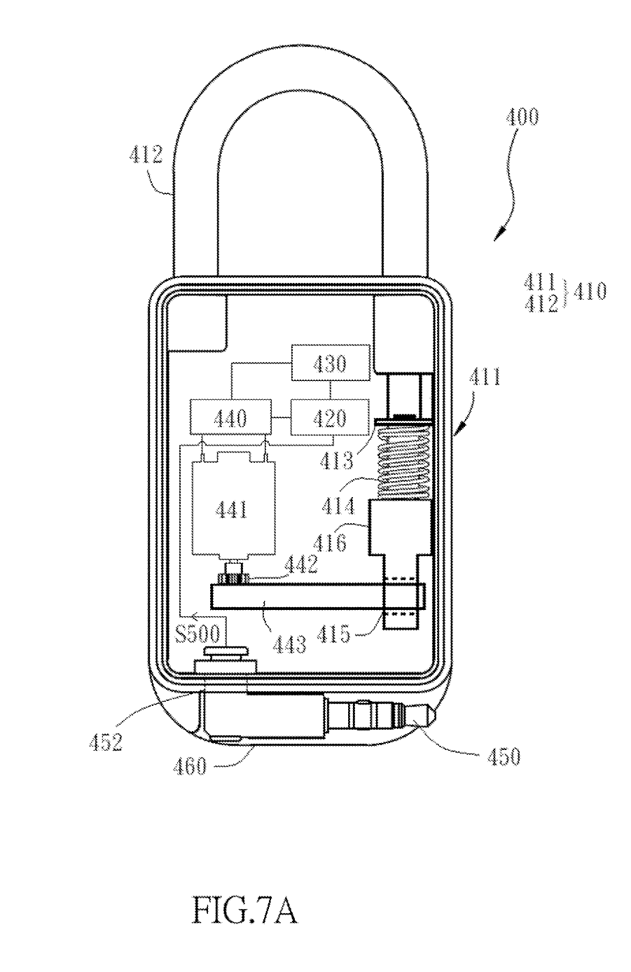

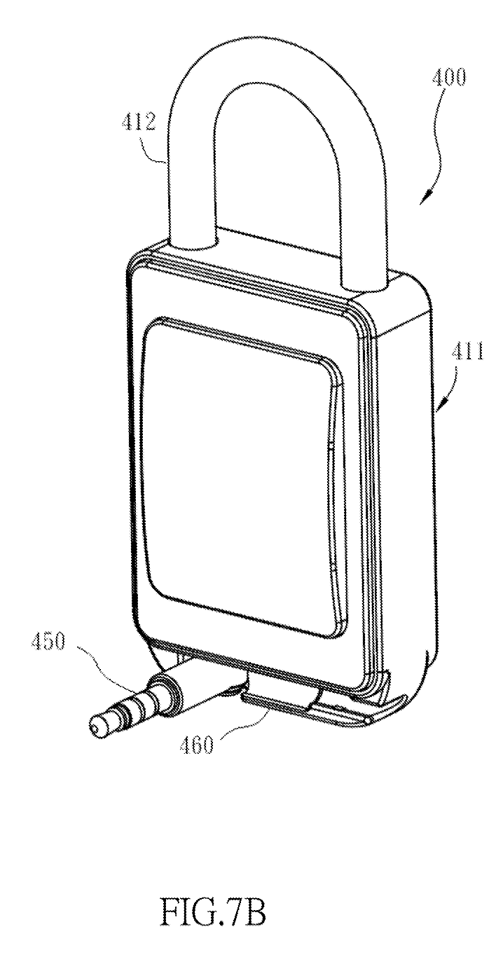

Please refer to FIG. 7A, which illustrates a schematic view of a lock system according to another embodiment of the present disclosed example. In this embodiment, the electronic lock 400 is connected to a portable device (not shown in figure) in wire form via headphone interface. The electronic lock 400 comprises a lock structure 410, a certification circuit 420 and a headphone interface 450 (take 3.5 mm audio connector for example). The certification circuit 420 comprises a database for storing at least one certification code. The lock structure comprises a lock case 411 and a shackle 412. When the electronic lock 400 is under a lock status, the lock structure 410 defines a close path for locking up the anti-theft-needed object in the close path, so as to achieve the effect of anti-theft. The portable device is electrically connected to the electronic lock 400 via the headphone interface; the portable device is used to transmit a data S500 to the electronic lock 400. The certification circuit 420 of the electronic lock 400 is coupled to the headphone interface 450. After receiving the data S500 transmitted from the portable device via the headphone interface 450, the certification circuit 420 confirms whether the data S500 has data identical to one of the at least one certification code. If so, the lock structure 410 translates into an open path from the close path for generating a gap (not shown in FIG. 7, please refer to the close path 119 shown in FIG. 1B) for making it convenient to move out the anti-theft-needed object via the gap.

In one embodiment, the electronic lock 400 can comprise a power stabilizing circuit 430 and a lock-releasing circuit 440. The lock-releasing circuit 440 is coupled to the certification circuit 420. After the certification circuit 420 confirms that the received data S500 is correct, the certification circuit 420 generates a release signal. When the lock-releasing circuit 440 receives the release signal, the electronic lock 400 controls a mechanical device to translate the status of the electronic lock into a non-lock status from a lock status. The power stabilizing circuit 430 is used to receive electrical energy and filters out the ripple in the electrical energy, and continuously outputs electrical power, which is not less than a predetermined power value to the certification circuit 420 and the lock-releasing circuit 440 in real-time or later. In one embodiment, the power stabilizing circuit 430 comprises at least one capacitor and is electrically connected to the headphone interface 450, for receiving and storing the electrical energy transmitted from the headphone interface 450. The power stabilizing circuit 430 may detect the capacitor voltage, and when the capacitor voltage reaches a predetermined voltage, the power stabilizing circuit 430 starts to output the electrical power, which is not less than the predetermined value to the certification circuit 420 and the lock-releasing circuit 440.

In this embodiment, the mechanical device comprises a motor 441, a gear 442 and a transverse rod 443. The motor 441 is controlled by the lock-releasing circuit 440 to rotate the gear 442. The gear 442 engages one end of the transverse rod 443 to drive the transverse rod 443 to move when the gear 442 rotates. The one side of the shackle 412 comprises a lock hole 415. When the shackle 412 locates at a shackle-locking position, the transverse rod 443 passes into or through the lock hole 415 and the mechanical device is under the lock status, so as to make the lock case 411 and the shackle 412 hook together to define a close path. When the transverse rod 443 moves out the lock hole 415, the mechanical device is under the non-lock status, so as to move up the shackle 412 relative to the lock case 411 to a shackle-unlocking position and form the gap between. At this time, the lock case 411 and the shackle 412 define the open path together.

In other embodiment, the electronic lock 400 may comprise a spring 414. The spring 414 locates in the lock case 411 and joints with one side of the shackle 412, and the one side of the shackle 412 movably inserts into a restricting base 416 in the lock case 411. The restricting base 416 simultaneously restricts the position of one side of the spring 414. The shackle 412 comprises a baffle 413 for controlling the position of the other side of the spring 414. When the electronic lock 400 is under the lock status, the shackle 412 located at the shackle-locking position and the spring 414 is compressed and stores energy. When the transverse rod 443 move out the lock hole 415, the spring 414 releases the stored energy and pushes up the shackle 412 to the shackle-unlocking position for generating the gap, so as to make the mechanical device automatically translate into the non-lock status when being unlocked.

Please be noted that the electronic 400 may additionally comprise an accommodating device 460 for headphone interfaces, which is preferably located on one side of the lock case 411. One side of the headphone interface 450 passes into the lock case 411 though a through hole 452 located on the lock case 411, so as to make the headphone interface 450 be electrically connected to the certification circuit 420. The junction of through hole 452 and the one side of headphone interface 450 is sealed and provides the waterproof effect via using the waterproof O-ring (not shown in figure). When the headphone interface 450 locates at the first position shown in FIG. 7A, namely the headphone interface 450 is accommodated in the accommodating device 460 for reducing the adhesion or pollution of external water or particles.

Please refer to FIG. 7B, which illustrates an appearance view of an electronic lock of FIG. 7A. One side of the accommodating device 460 is an opening used to allow the headphone interface 450 to transversely and rotatably move to a second position shown in FIG. 7B. For the convenience of users to rotate out the headphone interface 450, please simultaneously refer to the FIG. 7A, the other side of the headphone interface 450 slightly protrudes from the accommodating device 460 for making it convenient to apply force to rotate out the headphone interface 450. The maximum angle difference between the first position and the second position of headphone interface 450 is not less than 60 degrees preferably, and not less than 90 degrees more preferably.

Please be noted that the electronic lock 400, the lock structure 410, the lock case 411, the shackle 412, the baffle 413, the spring 414, the lock hole 415, the certification circuit 420, the power stabilizing circuit 430, the lock-releasing circuit 440, the motor 441, the gear 442, the transverse rod 443 and the data S500 shown in FIGS. 7A and 7B are similar to the lock 100, the lock structure 110, the lock case 111, the shackle 112, the baffle 113, the spring 114, the lock hole 115, the certification circuit 120, the power stabilizing circuit 130, the lock-releasing circuit 140, the motor 141, the gear 142, the transverse rod 143 and the data S200 shown in FIGS. 1A and 1B respectively, the relevant description is omitted for brevity.

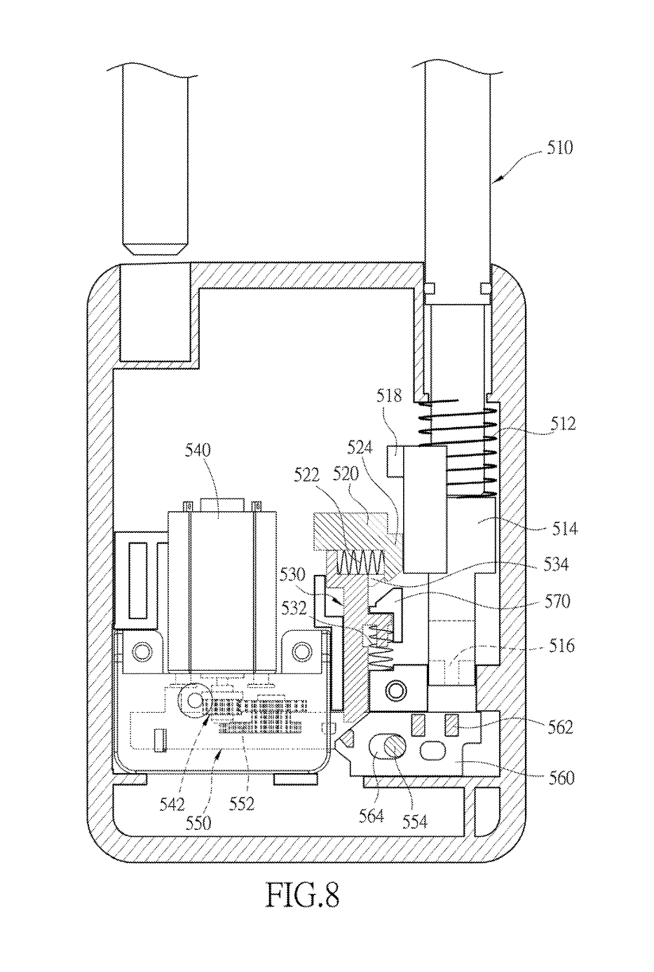

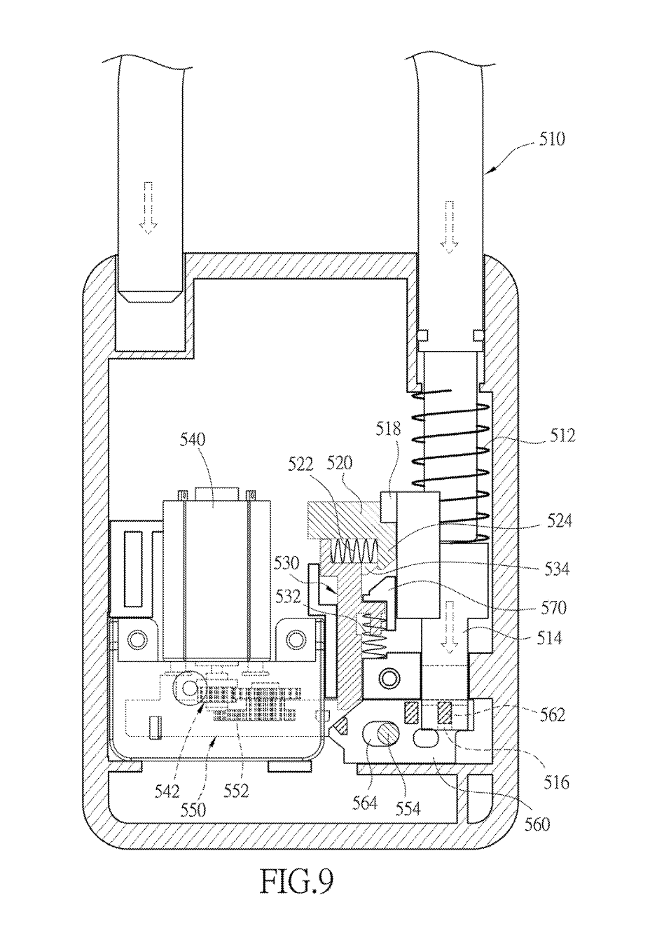

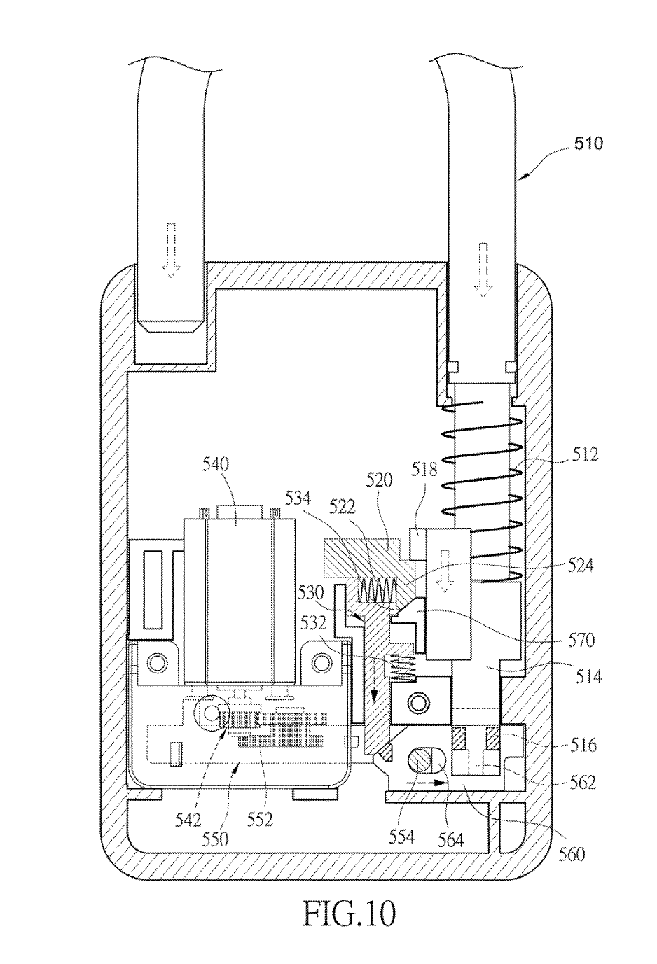

Please simultaneously refer to FIG. 8 to FIG. 10. FIG. 8 illustrates a schematic view of a mechanical device of an electronic lock translating under a non-lock status according to another embodiment of the present disclosed example. FIG. 9 illustrates a schematic view of a mechanical device of an electronic lock translating into a lock status from a non-lock status according to another embodiment of the present disclosed example. FIG. 10 illustrates a schematic view of a mechanical device of an electronic lock under a lock status according to another embodiment of the present disclosed example. The electronic lock of the present disclosed example comprises a mechanical device having a semi-automatic structure. The above-mentioned mechanical device under a non-lock status may receive an external force to passively enter the lock status, and automatically enter the non-lock status from the lock status via controlling a motor. Thus, during being locked, the electronic lock of the present disclosed example doesn't consume any power. The electronic lock of the present disclosed example is similar to the electronic lock shown in FIGS. 1A and 1B; the following description will only explain the difference between the two.

As shown in figures, in this embodiment, the mechanical device mainly comprises a shackle 510, a horizontal locking component 520, a vertical locking component 530, a motor 540, at least one gear (namely, first gear, take the gears 542 for example in this embodiment) and a transverse rod (namely, a driving transverse rod 550 and a locking transverse rod 560).

One side of the shackle 510 is jointed with a spring 512 (namely, first spring) which is arranged vertically, and is inserted into a restricting base 514 to be vertically moved therewith. Besides, when the shackle 510 moves to a shackle-locking position, the shackle 510 and the lock case form a close path together. When the shackle 510 moves to a shackle-unlocking position, the shackle 510 and the lock case form an open path together. The restricting base 514 is arranged on the shackle 510, and comprises a convex block 518 (namely, first convex block). The bottom of the restricting base 514 forms a groove 516 (take a linear groove for example in this embodiment) used to latch the transverse rod.

The horizontal locking component 520 comprises a spring 522 (namely, second spring) which is arranged horizontally and a convex block 524 (namely, second convex block) which is fixedly arranged toward a ramp block 570 on the lock case. The vertical locking component 530 comprises a spring 532 (namely, third spring) and a convex block 534 which is arranged toward the ramp block 570.

The transverse rod is used to fix and latch the shackle 510 located at the shackle-locking position. Preferably, the transverse rod comprises the driving transverse rod 550 and the locking transverse rod 560. The driving transverse rod 550 comprises a gear 552 (namely, second gear) which meshes one of the gears 542 and a convex block 544. The driving transverse rod 550 is driven by the gear 542 and gear 552 to move horizontally when the motor 540 rotates. The locking transverse rod 560 is connected to the driving transverse rod 550, and comprises at least one convex block 562 (namely, fourth convex block). In this embodiment, the convex block 562 is vertically arranged on the locking transverse rod 560 to form a linear locking structure corresponding to the groove 516. Preferably, the locking transverse rod 560 further forms a hole 564 used to accommodate a convex block 554 (namely, fifth convex block). Thus, when the driving transverse rod 550 moves horizontally, the driving transverse rod 550 can push the locking transverse rod 560 to move toward the same horizontal direction by the convex block 554.

The following description will explain how the mechanical device of the electronic lock of the present disclosed example receives the external force and passive entries the lock status from the non-lock status. As shown in FIG. 8, when the electronic lock is under the non-lock status, the user may manually apply force to push the shackle 510 toward a lock direction (the lock direction is the direction from top to bottom in this embodiment), so as to make the shackle 510 move from a shackle-unlocking position (namely, the position of the shackle 510 shown in FIG. 8) toward a shackle-locking position (namely, the position of the shackle 510 shown in FIG. 10). As shown in FIG. 9, during pushing, the shackle 510 continually extends the spring 512 and pushes down the restricting base 514 from an unlock position of the restricting base, so as to make the convex block 562 of the locking transverse rod 560 move into and then through the groove 516 of the restricting base 514. Then, as shown in FIG. 9, the user continuously applies force to the shackle 510 toward the lock direction, so as to make the convex block 518 of the restricting base 514 contact the horizontal locking component 520, pushing down the horizontal locking component 520 from an unlock position of horizontal locking component. At this time, the vertical locking component 530 is indirectly pushed down from an unlock position of the vertical locking component and continually compresses the spring 532 until the vertical locking component 530 contacts the ramp block 570 (as shown in FIG. 10).

Additionally, when the horizontal locking component 520 contacts the ramp block 570 while moving down, the horizontal locking component 520 will move along a slope direction of the ramp block 570 (take moving lower leftward for example in this embodiment) and still continually compresses the spring 522. When the bottom-side of the vertical locking component 530 contacts the left-side slope of the locking transverse rod 560 during moving down, the vertical locking component 530 pushes the locking transverse rod 560 toward a latching direction (left-to-right in this embodiment), so as to make the position of the convex block 562 deviate the upper entrance of the groove 516 (namely, pushing the locking transverse rod 560 to a lock position of fixing transverse rod), to be latched and vertically restrict the movement of the locking transverse rod 560. Thus, the restricting base 514 and the shackle 510 won't move up to unlock from the restoring force of the spring 512. Please be noted that the vertical locking component 530 had moved down and blocks the locking transverse rod 560 to limit the locking transverse rod 560 to moving leftward. Thus, the mechanical device of the electronic lock enters the lock status (as shown in FIG. 10), and forms a close path.

In the above-mentioned embodiments, the latching transverse rod is limited to moving leftward under the lock status by the convex block 518, the horizontal locking component 520 and the vertical locking component 530 being fixed and latched each other, but this specific example is not intended to limit the scope of the present disclosed example. In another embodiment, during locking (namely, the user is pushing down the shackle 510), the horizontal locking component 520 is pushed by the convex block 518 to move lower leftward along the slope direction of the ramp block 570. The vertical locking component 530 is pushed down by the horizontal locking component 520 to contact the left-side of the locking transverse rod 560 and pushes the locking transverse rod 560 to make the locking transverse rod 560 latch so the electronic lock is under the lock status. Then, when the user continually pushes down the shackle 512 to make the horizontal locking component 520 be continually pushed to a detachment position by the convex block 518, the horizontal locking component 520 detaches from convex block 518 caused by the motion leftward (namely, the horizontal locking component 520 doesn't contact the convex block 518 anymore). At the same time, the horizontal locking component 520, losing the downward force moves back to the unlock position of the horizontal locking component caused by the restoring force of the spring 522. The vertical locking component 530 losing the downward force moves back to the unlock position of vertical locking component caused by the restoring force of the spring 532

The following description will explain how the mechanical device of the electronic lock of the present disclosed example enters the non-lock status from the lock status. As shown in FIG. 10, when the electronic lock is under the lock status, the user may transmit the certification information and electronic energy to the electronic lock by using the portable device as above-mentioned description. The electronic lock operates by the received electronic energy and generates the release signal after determining that the certification information is identical to the pre-stored certification code. The motor 540 drives the gears to rotate after receiving the release signal, and makes the driving transverse rod 550 move toward an unlocking direction (the unlocking direction is right-to-left in this embodiment) via the gear 552. While the driving transverse rod 550 is moving, when the position of the convex block 562 moves to the entrance of the groove 516 and releases the latching status (namely, pulling the latching transverse rod to be at an unlock position of the latching transverse rod), the restricting base 514 and the shackle 510 move back to their unlock position respectively toward the unlock direction (the unlock direction is up) caused by the restoring force of the spring 512. At the same time, the vertical locking component 530 moves up to the unlock position of the vertical locking component caused by the restoring force of the spring 532, and the horizontal locking component 520 moves to the unlock position of horizontal locking component caused by the upward force of the vertical locking component 530 and the restoring force of the spring 522. Thus, the mechanical device of the electronic lock enters the non-lock status (as shown in FIG. 8), and forms the open path.

The above mentioned are only preferred specific examples in the present disclosed example, and are not thence restrictive to the scope of claims of the disclosed example. Therefore, those who apply equivalent changes incorporating contents from the present disclosed example are included in the scope of this application, as stated herein.

What is claimed is:

1. An electronic lock with certification function, comprising:
a certification circuit, used to receive data sent from an external device and determining according to the data whether to generate a release signal;
a lock-releasing circuit, coupled to the certification circuit and making a mechanical device translate into a non-lock status from a lock status when receiving the release signal; and
a power stabilizing circuit, used to receive electrical power and filter out the ripple in the electricity, and continuously outputting electrical power, which is not less than a predetermined power value, for a predetermined time or more to the certification circuit and the lock-releasing circuit.

2. The electronic lock with certification function according to claim 1, further comprising a wire transmission interface coupled to the power stabilizing circuit and used to connect to the external device, wherein the external device transmits the electricity to the power stabilizing circuit via the wire transmission interface.

3. The electronic lock with certification function according to claim 1, further comprising a built-in power source for providing the electricity.

4. The electronic lock with certification function according to claim 1, further comprising an induction circuit coupled to the power stabilizing circuit and used to generate the electricity induced by an electromagnetic wave generated by the external device.

5. The electronic lock with certification function according to claim 2, wherein the external device transmits the data via the wire transmission interface.

6. The electronic lock with certification function according to claim 2, wherein the wire transmission interface is a headphone interface, a USB interface, a Lightning interface or an IEEE 1394 interface.

7. The electronic lock with certification function according to claim 2, further comprising an induction circuit coupled to the certification circuit and used to generate the data induced by an electromagnetic wave generated by the external device.

8. The electronic lock with certification function according to claim 2, further comprising a light-sensing circuit coupled to the certification circuit and used to sense a light frequency, a variety of light intensity or a combination thereof for decoding the data transmitted from the external device.

9. The electronic lock with certification function according to claim 2, further comprising a sound-sensing circuit coupled to the certification circuit and used to sense an audio frequency, a variety of audio intensity or a combination thereof for decoding the data transmitted from the external device.

10. The electronic lock with certification function according to claim 1, further comprising a headphone interface coupled to the power stabilizing circuit and used to connected to the external device, wherein the external device transmits the electricity to the power stabilizing circuit via the headphone interface.

11. The electronic lock with certification function according to claim 2, wherein the mechanical device comprises:
a lock case;
a shackle, jointed with a first spring, moved to a shackle-locking position to compress the first spring and form a close path with the lock case, and moved to a shackle-unlocking position to form an open path with the lock case;
a transverse rod, used to latch the shackle located at the shackle-locking position; and
a motor, coupled to the lock-releasing circuit, driving the transverse rod via a first gear, and making the transverse rod detach from the shackle when receiving the release signal so as to make the shackle be moved back to the shackle-unlocking position by a restoring force of the first spring.

12. The electronic lock with certification function according to claim 11, wherein the mechanical device comprises:
a ramp block, fixedly installed on the lock case;
a restricting base, installed on the shackle and comprising a first convex block, and a groove that is formed in a bottom of the restricting base and used to latch the transverse rod;
a horizontal locking component, comprising a second spring and a second convex block installed toward the ramp block, the horizontal locking component moving toward a direction of being close to the ramp block when being pushed by the first convex block, and moving along a ramp direction of the ramp block and compressing the second spring after the second convex block contacts with the ramp block; and
a vertical locking component, comprising a third spring and a third convex block installed toward the ramp block, the vertical locking component compressing the third spring and the third convex being moved toward the direction of being close to the ramp block when being pushed by the horizontal locking component, and the vertical locking component restricting movement of the transverse rod after the third convex block contacts with the ramp block.

13. A portable device with certification function, comprising:
a storage circuit, storing data;
a data output circuit, coupled to the storage circuit and transmitting the data when being induced by an electronic lock or receiving a transmission command sent by a user; and
a built-in power source, providing the necessary electricity for making the storage circuit and the data output circuit operate.

14. The portable device with certification function according to claim 13, further comprising an induction coil coupled to the data output circuit and used to transmit the data in form of the electromagnetic waves.

15. The portable device with certification function according to claim 14, wherein a power value of the electromagnetic waves is 1 mW or more.

16. The portable device with certification function according to claim 13, further comprising a wire transmission interface coupled to the data output circuit and used to transmit the data in wire form, wherein the wire transmission interface is a headphone interface, a USB interface, a Lightning interface or an IEEE 1394 interface.

17. The portable device with certification function according to claim 16, wherein the wire transmission interface is further coupled to the built-in power source for transmit electricity with 1 mW or more.

18. The portable device with certification function according to claim 13 further comprising a sounding component coupled to the data output circuit and used to transmit the data in form of a variety of audio frequency, a variety of audio intensity or a combination thereof.

19. The portable device with certification function according to claim 13 further comprising a lighting component coupled to the data output circuit and used to transmit the data in form of a variety of light frequency, a variety of light intensity or a combination thereof.

20. A lock system with certification function, comprising:
an electronic lock, comprising a lock structure and a certification circuit, the certification circuit comprising a database for storing at least one certification code, and the lock structure used to define a close path; and
a portable device used to transmit certification information;
wherein the certification circuit verifies whether the received certification information has data identical to the at least one certification code after the electronic lock receives the certification information of the portable device, and the electronic lock makes lock structure change to an open path from the closed path if the certification information is identical to the at least one certification code.

21. The lock system with certification function according to claim 20, wherein the electronic lock and the portable device comprise a NFC module respectively, the portable device and the electronic lock respectively transmit and receive the certification information via their NFC module.

22. The lock system with certification function according to claim 20, wherein the certification information is a certification key, a user password, at least one device ID of the portable device or any combination thereof.

23. The lock system with certification function according to claim 22, wherein the device ID is an IMEI code, a MAC address, a Bluetooth address, a serial number of the portable device, a NFC serial number or any combination thereof.

24. The lock system with certification function according to claim 20 wherein the electronic lock without a display device comprises a lighting component or a sounding component, the lighting component continuously or periodically lights for a predetermined time or the sounding component continuously or periodically sounds for the predetermined time if the certification information has data identical to one of the least one certification code.

25. A pairing method of an electronic lock with certification function, comprising:
establishing a connection between the electronic lock and a first portable device for receiving data for certification;
comparing the certification data for certification with at least one certification code stored in a database of the electronic lock for verifying whether the certification data has data identical to one of the least one certification code;
storing at least part of the data of the certification data for certification in the database if the certification data has data identical to one of the least one certification code; and
modifying a flag from an unpaired status into a paired status.

26. The pairing method of an electronic lock with certification function according to claim 25, further comprising:
the electronic lock switching to a non-lock status from a lock status.

27. The pairing method of an electronic lock with certification function according to claim 25, wherein the certification data has a certification key, a user password, at least one device ID of the first portable device or a combination thereof.

28. The pairing method of an electronic lock with certification function according to claim 25, wherein the device ID is an IMEI code, a MAC address, a Bluetooth address, a serial number of the first portable device, a NFC serial number or a combination thereof.

29. The pairing method of an electronic lock with certification function according to claim 27, wherein the certification key is obtained via network.

30. The pairing method of an electronic lock with certification function according to claim 25, further comprising:
establishing the connection between the electronic lock and the first portable device for receiving an adding device data used to adding pairing device;
comparing the adding device data used to adding pairing device with a certification key stored in the database of the electronic lock;
controlling the electronic lock enter a status of adding pairing device if the adding device data has data identical to the certification key;
establishing a connection between the electronic lock and the second portable device for receiving pairing data used to adding pairing;
comparing the pairing data used to adding pairing with the least one certification code stored in the database of the electronic lock for verifying whether the pairing data has data identical to one of the least one certification code; and
storing at least part of the pairing data used to adding pairing device in the database if the pairing data has data identical to one of the least one certification code.
